(19) United States
(12) Patent Application Publication
(10) Pub. No.: US 2022/0403197 A1
(43) Pub. Date: Dec. 22, 2022

(54) THREE-DIMENSIONAL PRINTING WITH SCENT AGENTS

(71) Applicant: HEWLETT-PACKARD DEVELOPMENT COMPANY, L.P., SPRING, TX (US)

(72) Inventors: EMRE HIRO DISCEKICI, SAN DIEGO, CA (US); GRACIELA EMMA NEGRI JIMENEZ, SAN DIEGO, CA (US); SHANNON REUBEN WOODRUFF, SAN DIEGO, CA (US); CAROLIN FLEISCHMANN, SAN DIEGO, CA (US)

(21) Appl. No.: 17/777,751

(22) PCT Filed: Dec. 10, 2019
(86) PCT No.: PCT/US2019/065350

§ 371 Date: May 18, 2022

(51) Int. Cl. C09D 11/38; B33Y 10/00; B33Y 70/00; B29C 64/165; C09D 11/322; C09D 11/037; C09D 11/033; C09D 11/102

(52) U.S. Cl. CPC C09D 11/38; B33Y 10/00; B33Y 70/00; B29C 64/165; C09D 11/322; C09D 11/037; C09D 11/033; C09D 11/102; B29K 2077/00

(57) ABSTRACT

The present disclosure describes three-dimensional printing with scent agents. In one example, a multi-fluid kit for three-dimensional printing can include a fusing agent comprising water and a radiation absorber, wherein the radiation absorber absorbs radiation energy and converts the radiation energy to heat; and a scent agent comprising a scented compound dissolved in an aqueous liquid vehicle that includes water and organic co-solvent, wherein the organic co-solvent includes an aliphatic polyol, an esterified aliphatic polyol, or a combination thereof.

### BACKGROUND

Three-dimensional (3D) digital printing, a type of additive manufacturing, has continued to be developed over the years. In general, three-dimensional printing technology can shorten the product development cycle by allowing rapid creation of prototype models for reviewing and testing. However, three-dimensional printing has been somewhat limited with respect to commercial production capabilities because the range of materials used in three-dimensional printing is likewise limited. That stated, a wider variety of materials for use and new and/or modified three-dimensional printing applications has provided increased interest in this area in recent years.

### BRIEF DESCRIPTION OF THE DRAWINGS

FIG. 1 is a schematic view of an example multi-fluid kit for three-dimensional printing in accordance with examples of the present disclosure.

FIG. 2 is a schematic view of an example three-dimensional printing kit in accordance with examples of the present disclosure.

FIGS. 3A-3C show a schematic view of an example three-dimensional printing process using an example three-dimensional printing kit in accordance with examples of the present disclosure.

FIG. 4 is a flowchart illustrating an example method of making a three-dimensional printed article in accordance with examples of the present disclosure.

### DETAILED DESCRIPTION

The present disclosure describes multi-fluid kits for three-dimensional printing that include scent agents for making scented three-dimensional printed articles. The present disclosure also describes three-dimensional printing kits and methods of making three-dimensional printed articles. In one example, a multi-fluid kit for three-dimensional printing can include a fusing agent comprising water and a radiation absorber, and a scent agent comprising a scented compound dissolved in an aqueous liquid vehicle that includes water and organic co-solvent. In this example, the radiation absorber absorbs radiation energy and converts the radiation energy to heat, and the organic co-solvent includes an aliphatic polyol, an esterified aliphatic polyol, or a combination thereof. In one example, the organic co-solvent can include the aliphatic polyol, such as 1,3-butylene glycol, 1,2-propylene glycol, glycerol, a monoglyceride, or a combination thereof. In another example, the organic co-solvent can include the esterified aliphatic polyol, such as triethylene citrate, ethyl acetate, a monoglyceride, a diglyceride, a propylene glycol ester, a butylene glycol ester, or a combination thereof. The scented compound can be present in the scent agent in an amount from about 0.05 wt % to about 20 wt % based on the total weight of the scent agent. The scented compound can include, for example, a scented ester compound, a scented linear terpene compound, a scented cyclic terpene compound, a scented aromatic compound, a scented alcohol compound, a scented aldehyde compound, a scented ketone compound, a scented lactone compound, a scented thiol compound, or a combination thereof. In one example, a detailing agent can be included as an additional fluid, which includes a detailing compound to reduce the temperature of powder bed material onto which the detailing agent is applied.

In another example, a three-dimensional printing kit can include a powder bed material comprising polymer particles, and a fusing agent to selectively apply to the powder bed material. The fusing agent can include an aqueous liquid vehicle including water and an organic co-solvent, a radiation absorber to absorb radiation energy and convert the radiation energy to heat, and a scented compound dissolved in the aqueous liquid vehicle. The organic co-solvent can include an aliphatic polyol, an esterified aliphatic polyol, or a combination thereof. In one example, the polymer particles can include polyamide 6, polyamide 9, polyamide 11, polyamide 12, polyamide 66, polyamide 612, thermoplastic polyamide, polyamide copolymer, polyethylene, thermoplastic polyurethane, polypropylene, polyester, polycarbonate, polyether ketone, polyacrylate, polystyrene, polyvinylidene fluoride, polyvinylidene fluoride copolymer, poly (vinylidene fluoride-trifluoroethylene), poly (vinylidene fluoride-trifluoroethylene-chlorotrifluoroethylene), wax, or a combination thereof. In another example, the scented compound can be present in the fusing agent in an amount from about 0.05 wt % to about 20 wt % based on the total weight of the fusing agent. The scented compound can include a scented ester compound, a scented linear terpene compound, a scented cyclic terpene compound, a scented aromatic compound, a scented alcohol compound, a scented aldehyde compound, a scented ketone compound, a scented lactone compound, a scented thiol compound, or a combination thereof. In one example, the three-dimensional printing kit can include a detailing agent including a detailing compound to reduce the temperature of powder bed material onto which the detailing agent is applied.

In another example, a method of making a three-dimensional printed article can include iteratively applying individual layers of a powder bed material to a powder bed, and based on a three-dimensional object model, selectively applying a fusing agent onto the individual layers of powder bed material. The fusing agent can include water and a radiation absorber to absorb radiation energy and convert the radiation energy to heat, and the powder bed material can include polymer particles. In further detail, the method can include, based on the three-dimensional object model, selectively applying a scented compound dissolved in an aqueous liquid vehicle including water and an organic co-solvent to the powder bed material, and exposing the powder bed to radiation energy to selectively fuse the polymer particles in contact with the radiation absorber at individual layers and thereby forming the three-dimensional printed article. In this example, the organic co-solvent can include an aliphatic polyol, an esterified aliphatic polyol, or a combination thereof. In one example, the scented compound can be present in a scent agent that is a separate fluid relative to the fusing agent. In another example, the scented compound can be present in the fusing agent, which includes the aqueous liquid. In another example, applying the fusing agent and scented compound can include ejecting the fusing agent from a fluidjet printhead with the scented compound included in the fusing agent, or ejecting the fusing agent and a separate scent agent from the fluidjet printhead, wherein the scented compound is included in the separate scent agent.

The multi-fluid kits, three-dimensional printing kits, and methods described herein can be used to make three-dimensional (3D) printed articles that include a scented compound to provide a particular scent to the finished three-dimensional printed articles. The fluids and materials described herein can be used, in some examples, with certain three-dimensional printing processes that involve fusing layers of polymer powder to form solid layers of a three-dimensional printed article. In one process, a fusing agent can be jetted onto a powder bed of polymer particles. The fusing agent can include a radiation absorber, which can be a material that absorbs radiant energy and converts the energy to heat. Radiant energy can be applied to the powder bed to heat and fuse the polymer particles on which the fusing agent was applied.

In some cases, a scented compound can be added to the fusing agent or as part of a separate jettable fluid agent. The scented fusing agent or separate scent agent can be used during the three-dimensional printing process so that the finished three-dimensional printed article can have the scent of the particular scented compound used. This can be useful for many different types of three-dimensional printed articles in which a characteristic scent is desired. For example, three-dimensional printed dental equipment may benefit from the inclusion of a scented compound, which can be a fragrance or even a scented flavoring agent, such as a mint scent or flavor. Other examples can include three-dimensional printed articles having a fragrance designed to cover up other odors. For example, customized insoles for footwear can be produced through three-dimensional printing. Such three-dimensional printed insoles can include a fragrance to mitigate unpleasant foot odors. Other three-dimensional printed devices for personal wear, such as clothing items, prosthetics, and so on can also be formed with a fragrance to mask body odors, for example. In further examples, it can be desired to impart a characteristic fragrance to a three-dimensional printed article for aesthetic appeal and to provide a particular end-user experience. Accordingly, a wide variety of three-dimensional printed articles can be made with a wide variety of scents using the materials and methods described herein.

In some cases, multiple different scented agents can be used together. Three-dimensional printed articles can be formed with different scents located in different portions of the article. In other examples, multiple different scents can be used in the same area to create a mixed scent or a new scent that results from the combination of multiple scents. Because the build material is usually unscented and the scented compound is contained in a fluid agent to be selectively applied to the build material, it can be a simple matter to switch scents or use multiple different scents without changing the build material. In some examples, scented agents can be used selectively to form some three-dimensional printed articles that are scented while simultaneously forming other three-dimensional printed articles that are unscented. Thus, adding scented compounds to any of the fluid agents in the multi-fluid kit or the printing kits described herein can provide a wide degree of flexibility in making scented and unscented three-dimensional printed articles.

### Multi-Fluid Kits for Three-Dimensional Printing

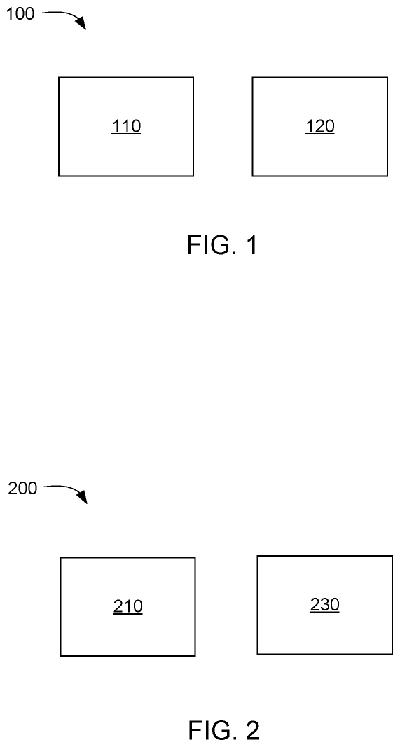

With this description in mind, FIG. 1 shows a schematic illustration of an example multi-fluid kit 100 for three-dimensional printing. The kit includes a fusing agent 110 and a scent agent 120. The fusing agent can include water and a radiation absorber. The radiation absorber can absorb radiation energy and convert the radiation energy to heat. The scent agent can include a scented compound dissolved in an aqueous liquid vehicle that includes water and organic co-solvent. The organic co-solvent in this example can include an aliphatic polyol, an esterified aliphatic polyol, or a combination thereof, which are solvents that are sometimes used (with or without added water) to carry scented compounds for formulating the scent agents of the present disclosure.

In one example, the scented compound can be “chemically stable,” meaning that it can be used with reference to the scented compound to describe scented compounds that do not chemically decompose or react to form different chemical compounds when heated to a particular elevated temperature coinciding with the temperatures used for three-dimensional printing as described herein. In some examples, the temperature can be the melting point temperature of polymer powder that is used together with the scent agent 120. That is, the scent agent can be chemically stable at the melting point temperature of the polymer powder. Therefore, when the polymer powder is heated sufficiently to fuse the polymer powder together (which may be at or near the melting point temperature) the scented compound can remain effective. Alternatively, if the scented compound begins to decompose or react at the melting point temperature, the decomposition or reaction can be sufficiently slow that less than 20 wt % of scented compound decomposes or reacts while the polymer particles are being fused together. In some examples, the polymer powder can have a melting point temperature from about 70° C. to about 350° C. Therefore, in some examples, the scented compound can be chemically stable at a temperature from about 70° C. to about 350° C. In many cases, the scented compound can be chemically stable at the melting point of the polymer particles, and the scented compound can also be chemically stable to a temperature significantly higher than the melting point of the polymer particles.

In further examples, the multi-fluid kit 100 for three-dimensional printing can be paired with a powder bed material (described in further detail below) to provide a three-dimensional printing kit. In other examples, the multi-fluid kit can also include other fluids, such as detailing agents, coloring agents, or the like. For example, the detailing agent can include a detailing compound, which is a compound that can reduce the temperature of powder bed material onto which the detailing agent is applied. In some examples, the detailing agent can be applied around edges of the area where the fusing agent is applied. This can prevent powder bed material around the edges from caking due to heat from the area where the fusing agent was applied. The detailing agent can also be applied in the same area where fusing was applied in order to control the temperature and prevent excessively high temperatures when the powder bed material is fused.

### Three-Dimensional Printing Kits

The present disclosure also sets forth three-dimensional printing kits. In some examples, the three-dimensional printing kits can include materials that can be used in the three-dimensional printing processes described herein. FIG. 2 shows a schematic illustration of one example three-dimensional printing kit 200 in accordance with examples of the present disclosure. The kit includes a powder bed material 230 including polymer particles, and a fusing agent 210 to selectively apply to the powder bed material. In this example, a scented compound is included in the fusing agent so that the three-dimensional printed article formed using the fusing agent will have the scent of the scented compound. The scented compound can be as described previously in FIG. 1.

The three-dimensional printing kits 200 can likewise include multiple fluid agents, such as any combination of a fusing agent, a detailing agent, a coloring agent, a scent agent, powder bed material, etc. For example, three-dimensional printing kits may include a powder bed material, a fusing agent, and a scent agent.

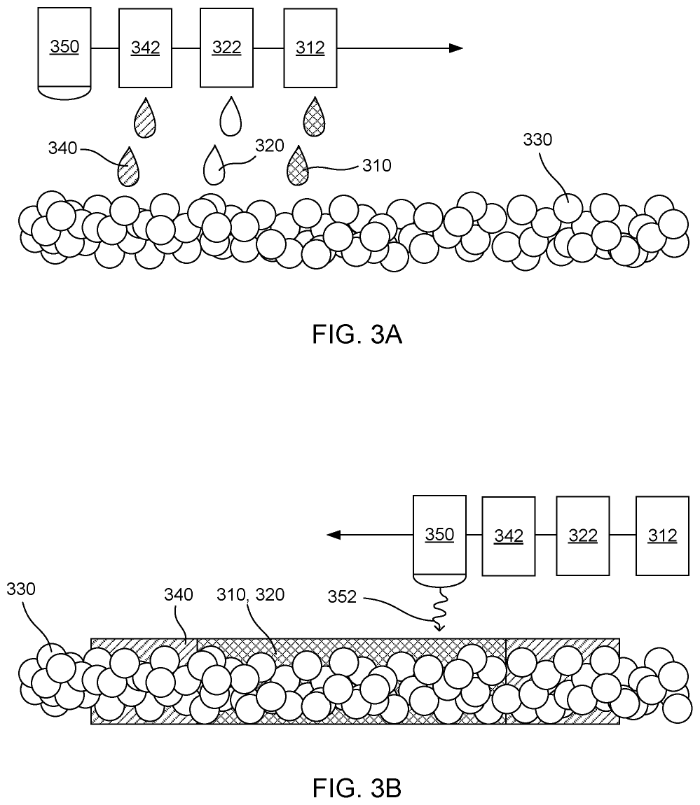

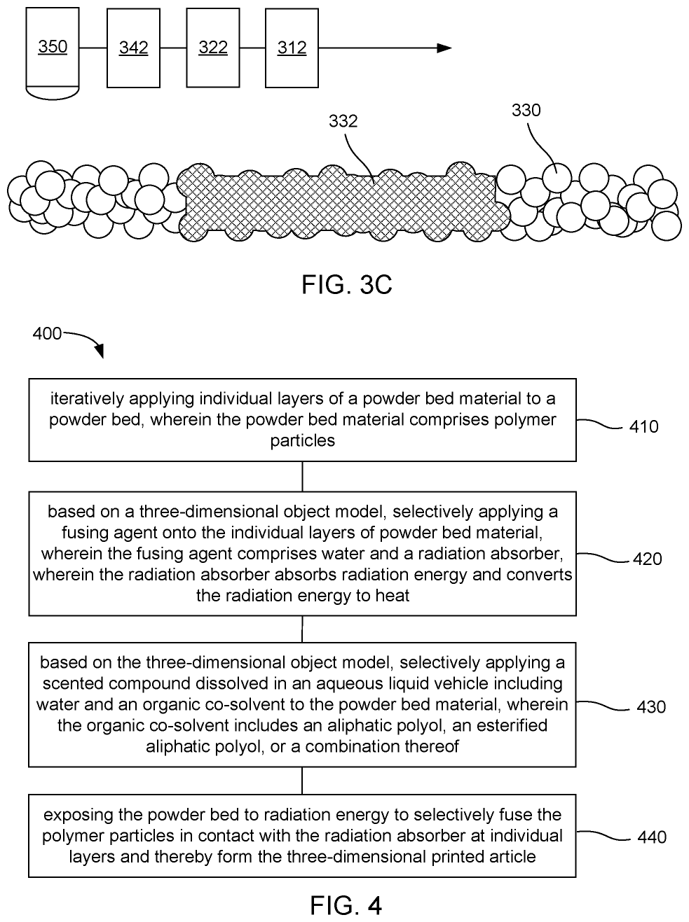

To illustrate the use of the three-dimensional printing kits and multi-fluid kits described herein, FIGS. 3A-3C illustrate one example of using a three-dimensional printing kit to form a three-dimensional printed article. In FIG. 3A, a fusing agent 310 and a scent agent 320 are jetted onto a layer of powder bed material 330. As also shown in FIGS. 3A-3C, a detailing agent can also be jetted in some more specific examples. The fusing agent is jetted from a fusing agent ejector 312, the scent agent is jetted from a scent agent ejector 322, and the detailing agent is jetted from a detailing agent ejector 342. As a note, in some examples not shown, the fusing agent can include the scented compound instead of or in addition to the use and presence of a separate scent agent. Regardless of the specific configuration and/or combinations of fluids (or with a single fluid in some instances) fluid ejectors can move across the layer of powder bed material to selectively jet fusing agent on areas that are to be fused, while the detailing agent can be jetted onto areas that are to be cooled. The scent agent can be jetted in areas where the particular scent of the scented compound is desired. A radiation source 350 can also move across the layer of powder bed material.

FIG. 3B shows the layer of powder bed material 330 after the fusing agent 310 and the scent agent 320 have been jetted onto an area of the layer that is to be fused. Additionally, the detailing agent 340 has been jetted onto areas adjacent to the edges of the area to be fused. In this figure, the radiation source 350 is shown emitting radiation 352 toward the layer of polymer particles. The fusing agent can include a radiation absorber that can absorb this radiation and convert the radiation energy to heat.

FIG. 3C shows the layer of powder bed material 330 with a fused portion 332 where the fusing agent was jetted. This portion has reached a sufficient temperature to fuse the polymer particles together to form a solid polymer matrix. This portion can also include the scented compound from the scent agent, which was also jetted in the same area as the fusing agent. The scented compound can be chemically stable at the melting temperature of the polymer particles, so the scented compound can remain effective after the polymer particles have been fused. The area where the detailing agent was jetted remains as loose polymer particles.

In various examples, the scent agent can be jetted onto portions of the individual powder bed material layers to form a portion of the final three-dimensional printed article that has the scented compound embedded in the fused polymer matrix. In some examples, the scent agent can be jetted in all the same areas where the fusing agent is jetted (or the scent agent may be used as the fusing agent in some cases, as mentioned above, or alternatively the fusing agent can include a scented compound so that the fusing agent also acts as a scent agent) and the resulting three-dimensional printed article can have the scented compound distributed throughout the entire article. In other examples, the scent agent may be selectively jetted in some areas and not in other areas where the fusing agent was jetted. This can result in a three-dimensional printed article that has some portions without scented compound and some portions with scented compound. In still further examples, additional scent agents with different scented compounds can be used to make multiple portions of the three-dimensional printed article with multiple different scents.

### Powder Bed Material

In certain examples, the powder bed material can include polymer particles having a variety of shapes, such as substantially spherical particles or irregularly-shaped particles. In some examples, the polymer powder can be capable of being formed into three-dimensional printed objects with a resolution of about 20 μm to about 100 μm, about 30 μm to about 90 μm, or about 40 μm to about 80 μm. As used herein, “resolution” refers to the size of the smallest feature that can be formed on a three-dimensional printed object. The polymer powder can form layers from about 20 μm to about 100 μm thick, allowing the fused layers of the printed part to have roughly the same thickness. This can provide a resolution in the z-axis (i.e., depth) direction of about 20 μm to about 100 μm. The polymer powder can also have a sufficiently small particle size and sufficiently regular particle shape to provide about 20 μm to about 100 μm resolution along the x-axis and y-axis (i.e., the axes parallel to the top surface of the powder bed). For example, the polymer powder can have an average particle size from about 20 μm to about 100 μm. In other examples, the average particle size can be from about 20 μm to about 50 μm. Other resolutions along these axes can be from about 30 μm to about 90 μm or from 40 μm to about 80 μm.

The polymer powder can have a melting or softening point from about 70° C. to about 350° C. In further examples, the polymer can have a melting or softening point from about 150° C. to about 200° C. A variety of thermoplastic polymers with melting points or softening points in these ranges can be used. For example, the polymer powder can be polyamide 6 powder, polyamide 9 powder, polyamide 11 powder, polyamide 12 powder, polyamide 6/6 powder, polyamide 6/12 powder, thermoplastic polyamide powder, polyamide copolymer powder, polyethylene powder, wax, thermoplastic polyurethane powder, acrylonitrile butadiene styrene powder, amorphous polyamide powder, polymethylmethacrylate powder, ethylene-vinyl acetate powder, polyarylate powder, silicone rubber, polypropylene powder, polyester powder, polycarbonate powder, copolymers of polycarbonate with acrylonitrile butadiene styrene, copolymers of polycarbonate with polyethylene terephthalate, polyether ketone powder, polyacrylate powder, polystyrene powder, polyvinylidene fluoride powder, polyvinylidene fluoride copolymer powder, poly (vinylidene fluoride-trifluoroethylene) powder, poly (vinylidene fluoride-trifluoroethylene-chlorotrifluoroethylene) powder, or mixtures thereof. In a specific example, the polymer powder can be polyamide 12, which can have a melting point from about 175° C. to about 200° C. In another specific example, the polymer powder can be thermoplastic polyurethane.

The thermoplastic polymer particles can also in some cases be blended with a filler. The filler can include inorganic particles such as alumina, silica, fibers, carbon nanotubes, cellulose, or combinations thereof. When the thermoplastic polymer particles fuse together, the filler particles can become embedded in the polymer, forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In some examples, a weight ratio of thermoplastic polymer particles to filler particles can be from about 100:1 to about 1:2 or from about 5:1 to about 1:1.

### Fusing Agents

The multi-fluid kits and three-dimensional printing kits described herein can include a fusing agent to be applied to the polymer build material. The fusing agent can include a radiation absorber that can absorb radiant energy and convert the energy to heat. In certain examples, the fusing agent can be used with a powder bed material in a particular three-dimensional printing process. A thin layer of powder bed material can be formed, and then the fusing agent can be selectively applied to areas of the powder bed material that are desired to be consolidated to become part of the solid three-dimensional printed object. The fusing agent can be applied, for example, by printing such as with a fluid ejector or fluid jet printhead. Fluid jet printheads can jet the fusing agent in a similar way to an inkjet printhead jetting ink. Accordingly, the fusing agent can be applied with great precision to certain areas of the powder bed material that are desired to form a layer of the final three-dimensional printed object. After applying the fusing agent, the powder bed material can be irradiated with radiant energy. The radiation absorber from the fusing agent can absorb this energy and convert it to heat, thereby heating any polymer particles in contact with the radiation absorber. An appropriate amount of radiant energy can be applied so that the area of the powder bed material that was printed with the fusing agent heats up enough to melt the polymer particles to consolidate the particles into a solid layer, while the powder bed material that was not printed with the fusing agent remains as a loose powder with separate particles.

In some examples, the amount of radiant energy applied, the amount of fusing agent applied to the powder bed, the concentration of radiation absorber in the fusing agent, and the preheating temperature of the powder bed (i.e., the temperature of the powder bed material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. Generally, the print mode can include any variables or parameters that can be controlled during three-dimensional printing to affect the outcome of the three-dimensional printing process.

Generally, the process of forming a single layer by applying fusing agent and irradiating the powder bed can be repeated with additional layers of fresh powder bed material to form additional layers of the three-dimensional printed article, thereby building up the final object one layer at a time. In this process, the powder bed material surrounding the three-dimensional printed article can act as a support material for the object. When the three-dimensional printing is complete, the article can be removed from the powder bed and any loose powder on the article can be removed.

Accordingly, in some examples, the fusing agent can include a radiation absorber that is capable of absorbing electromagnetic radiation to produce heat. The radiation absorber can be colored or colorless. In various examples, the radiation absorber can be a pigment such as carbon black pigment, glass fiber, titanium dioxide, clay, mica, talc, barium sulfate, calcium carbonate, a near-infrared absorbing dye, a near-infrared absorbing pigment, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In further examples, the radiation absorber can be a near-infrared absorbing conjugated polymer such as poly (3,4-ethylenedioxythiophene)-poly (styrenesulfonate) (PEDOT:PSS), a polythiophene, poly (p-phenylene sulfide), a polyaniline, a poly (pyrrole), a poly (acetylene), poly (p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂₀₇, M₄P₂O₉, M₅P₂O₁₀, M₃ (PO₄)₂, M (PO₃)₂, M₂P₄O₁₂, and combinations thereof, where M represents a counterion having an oxidation state of +₂, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +₂. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes. Non-limiting specific examples include complexes based on nickel, palladium, and platinum.

In further examples, the radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

In alternative examples, the radiation absorber can preferentially absorb ultraviolet radiation. In some examples, the radiation absorber can absorb radiation in wavelength range from about 300 nm to about 400 nm. In certain examples, the amount of electromagnetic energy absorbed by the fusing agent can be quantified as follows: a layer of the fusing agent having a thickness of 0.5 μm after liquid components have been removed can absorb from 90% to 100% of radiant electromagnetic energy having a wavelength within a wavelength range from about 300 nm to about 400 nm. The radiation absorber may also absorb little or no visible light, thus making the radiation absorber transparent to visible light. In certain examples, the 0.5 μm layer of the fusing agent can absorb from 0% to 20% of radiant electromagnetic energy in a wavelength range from above about 400 nm to about 700 nm. Non-limiting examples of ultraviolet absorbing radiation absorbers can include nanoparticles of titanium dioxide, zinc oxide, cerium oxide, indium tin oxide, or a combination thereof. In some examples, the nanoparticles can have an average particle size from about 2 nm to about 300 nm, from about 10 nm to about 100 nm, or from about 10 nm to about 60 nm.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the polymer powder, the amount of radiation absorber in the polymer powder can be from about 0.0003 wt % to about 10 wt %, or from about 0.005 wt % to about 5 wt %, with respect to the weight of the polymer powder.

In some examples, the fusing agent can be jetted onto the polymer powder build material using a fluid jetting device, such as inkjet printing architecture. Accordingly, in some examples, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the aqueous liquid vehicle formulation can include organic co-solvent(s) present in total at from about 1 wt % to about 50 wt %, depending on the jetting architecture. Further, a non-ionic, cationic, and/or anionic surfactant can be present, ranging from about 0.01 wt % to about 5 wt %. In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, materials for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments, or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to, liponic esters such as Tergitol™ 15-S-12, Tergitol™ 15-S-7 available from Dow Chemical Company (Michigan), LEG-1 and LEG-7; Triton™ X-100; Triton™ X-405 available from Dow Chemical Company (Michigan); and sodium dodecylsulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present at from about 0.01 wt % to about 20 wt %.

As mentioned above, in some examples, the fusing agent can include the scented compound described herein, and thus, when the scented compound is present, the fusing agent also includes an aliphatic polyol, an esterified aliphatic polyol, or a combination thereof as part of the aqueous liquid vehicle. These types of organic co-solvents may be used to prepare scented fluid formulations for consumer use as flavorings or fragrances, and these scented fluid formulations can be in the form of solutions, dispersions, emulsions, or the like. Thus, in some cases the fusing agent and the scent agent can be one and the same. The fusing agent can include the scented compound in an amount from 0.05 wt % to 20 wt %, from 0.1 wt % to 15 wt %, from 0.5 wt % to 10 wt %, or from 1 wt % to 8 wt %, based on the total weight of the scent agent. In other examples, the scented compound can be in a separate fluid agent, such as a scent agent.

### Scent Agents

In some examples, the multi-fluid kits or three-dimensional printing kits, and methods thereof, can include a scent agent. Generally, the scent agent can include a scented compound dissolved in an aqueous liquid vehicle that includes water and organic co-solvent. Thus, in accordance with examples of the present disclosure, a scent agent can be prepared by admixing a scented fluid formulation (which includes the scented compound and the organic co-solvent) with liquid vehicle components so that the formulation is suitable for ejection from a three-dimensional printer or printing system, for example. In still further detail, the scented compound can be chemically stable at the melting point temperature of polymer particles with which the scent agent is used, such as from 70° C. to 350° C., from 85° C. to 250° C., or from 100° C. to 200° C.

Regarding the organic co-solvent that can be included in the scented fluid formulation for further formulation to prepare the scent agents of the present disclosure, as mentioned, these organic co-solvents can include an aliphatic polyol, an esterified aliphatic polyol, or a combination thereof. These types of organic co-solvents may be used to prepare scented fluid formulations for consumer use as flavorings or fragrances, and these scented fluid formulations can be in the form of solutions, dispersions, emulsions, or the like. These scented fluid formulations can thus be used to prepare the scent agents of the present disclosure. By way of example, the organic co-solvent can include an aliphatic polyol, such as 1,3-butylene glycol, 1,2-propylene glycol, glycerol, a monoglyceride, or a combination thereof. In another example, the organic co-solvent can include an esterified aliphatic polyol, wherein the esterified aliphatic polyol includes triethylene citrate, ethyl acetate, a monoglyceride, a diglyceride, a propylene glycol ester, a butylene glycol ester, or a combination thereof.

In some examples, the scented compound can be water-soluble, and in other examples, the scented compound can be soluble in the aqueous liquid vehicle, which includes water and the organic co-solvent component as illustrated above. For example, if the scented compound is less soluble or insoluble in water, and thus, the organic co-solvent also present in the liquid vehicle can be used to assist in dissolving the scented compound, for example. As referred to herein, a water-soluble scented compound can be sufficiently soluble in water or the aqueous liquid vehicle so that the amount of scented compound that can be dissolved in water is sufficient to provide a detectable scent in a finished three-dimensional printed article if the solution of the scent agent is applied during three-dimensional printing. In some examples, the scented compound can form a solution with the liquid vehicle, and can be present in the scent agent at from 0.05 wt % to 20 wt %, from 0.1 wt % to 15 wt %, from 0.5 wt % to 10 wt %, or from 1 wt % to 8 wt %, based on the total weight of the scent agent. A portion or all of the scented compound can be solubilized in the aqueous liquid vehicle. Typically, the fragrance can be noticeable when the scented compound is solubilized on the aqueous liquid vehicle, so in accordance with one example, there can be from 0.5 wt % to 20 wt %, from 1 wt % to 20 wt %, from 2 wt % to 20 wt %, or from 4 wt % to 20 wt % scented compound dissolved in the aqueous liquid vehicle based on the total weight of the scent agent. In still other examples, the scent agent can include a dispersant to disperse the scented compound in the scent agent.

The scent agent can include a liquid vehicle. The scented compound can be dissolved or dispersed in the liquid vehicle, which includes water and an organic co-solvent. For example, the aqueous liquid vehicle can include from 50 wt % to 95 wt % water and from 5 wt % to 50 wt % of organic co-solvent, with all or a portion of the organic co-solvent including an aliphatic polyol, an esterified aliphatic polyol, or a combination thereof. The aliphatic polyol and/or the esterified aliphatic polyol can be included in the scent agent

The scent agent can also include ingredients to allow the scent agent to be jetted by a fluid jet printhead. In some examples, the scent agent can include jettability imparting ingredients such as those in the fusing agent described above. These ingredients can include a surfactant, dispersant, co-solvent, biocides, viscosity modifiers, materials for pH adjustment, sequestering agents, preservatives, and so on. These ingredients can be included in any of the amounts described above.

Scented Compounds for Inclusion in Fusing Agent and/or Scent Agent.

In accordance with examples of the present disclosure, the scented compound can be any of a number of compounds from a variety of chemical classes, or even combinations of chemical classes. For example, the scented compound can be a scented ester compound, a scented linear terpene compound, a scented cyclic terpene compound, a scented aromatic compound, a scented alcohol compound, a scented aldehyde compound, a scented ketone compound, a scented lactone compound, a scented thiol compound, or a combination thereof.

Examples of scented ester compounds, along with a non-limiting approximate description of their respective scents are as follows: linalyl acetate (fruity, mint), fructone (fruity, apple-like), hexyl acetate (apple, flowery, fruity), ethyl methylphenylglycidate (strawberry), geranyl acetate (fruity, rose) methyl formate (ethereal), methyl acetate (sweet, nail polish), methyl propionate (sweet, fruity, rum-like), methyl butyrate (fruity, apple, pineapple), ethyl butyrate (fruity, orange, pineapple), isoamyl acetate (fruity, banana, pear), pentyl butyrate (fruity, pear, apricot), pentyl pentanoate (fruity, apple), octyl acetate (fruity, orange), benzyl acetate (fruity, strawberry), or methyl anthranilate (fruity, grape).

Examples of scented linear terpene compounds, along with a non-limiting approximate description of their respective scents are as follows: linalyl acetate (fruity, mint), geraniol (sweet rose), myrcene (woody), geraniol (rose, flowery), nerol (sweet rose, flowery), citral or neral (lemon), citronellal (lemon), citronellol (lemon), linalool (sweet, flowery, woody, lavender), or nerolidol (woody, fresh bark).

Examples of scented cyclic terpene compounds, along with a non-limiting approximate description of their respective scents are as follows: limonene (orange), camphor (camphor), menthol (menthol, peppermint), carvone (caraway or spearmint based on chirality), terpineol (lilac), alpha-ionone (violet, woody), thujone (minty), or eucalyptol (eucalyptus).

Examples of scented aromatic compounds, along with a non-limiting approximate description of their respective scents are as follows: piperonal (flowery), benzaldehyde (almond), eugenol (clove), cinnamaldehyde (cinnamon), ethyl maltol (cooked fruit, caramelized sugar), vanillin (vanilla), ethyl vanillin (vanilla), anisole (anise), parapropenyl anisole (anise), estragole (tarragon), or thymol (thyme).

Examples of scented alcohol compounds, along with a non-limiting approximate description of their respective scents are as follows: acetoin (buttery odor), geraniol (sweet rose), furaneol (strawberry), 1-hexanol (herbaceous, woody), cis-3-hexene-1-ol (fresh cut grass), or methol (menthol peppermint).

Examples of scented aldehydes compounds, along with a non-limiting approximate description of their respective scents are as follows: piperonal (flowery), decanal (orange, citrus peel), acetaldehyde (ethereal), hexanal (green, grassy), cis-3-hexenal (green tomatoes), furfural (burnt oats), hexyl cinnamaldehyde (sweet, flowery, jasmine), isovaleraldehyde (nutty, fruity, cocoa-like), anisic aldehyde (flowery, sweet, hawthorn), or cuminaldehyde (spicy, cumin-like).

Examples of scented ketone compounds, along with a non-limiting approximate description of their respective scents are as follows: cyclopentadecanone (musk-ketone), dihydrojasmone (fruity, woody, flowery), oct-1-en-3-one (blood, metallic, mushroom-like), 2-acetyl-1-pyrroline (fresh bread, jasmine rice), or 6-acetyl-2,3,4,5-tetrahydropyridine (fresh bread, tortillas, popcorn).

Examples of scented lactone compounds, along with a non-limiting approximate description of their respective scents are as follows: gamma-decalactone (peach), gamma-nonalactone (coconut), delta-octalactone (cocoa, coconut, peach), jasmine lactone (peach, apricot), massoia lactone (coconut), wine lactone (sweet, coconut), or sotolon (maple syrup, curry, fenugreek).

Examples of scented thiol compounds, along with a non-limiting approximate description of their respective scents are as follows: allyl thiol (garlic), ethanethiol (smell of propane additive), grapefruit mercaptan (grapefruit) methanethiol (asparagus), furan-2-ylmethanethiol (roasted coffee), or benzyl mercaptan (leek, garlic).

In some examples, the scented compound can be a furanone derivative that has a scent. A variety of furanone derivatives can have different scents that mimic scents of foods, spices, or other desirable scents. As used herein, “furanone” refers to a chemical compound that includes the structure of a furan ring with an oxygen atom double bonded to one of the carbon atoms of the furan rings, with “furanone derivative(s)” including a pendent or functional group(s) attached to one or multiple carbon atoms present on the furan ring. Some furanone derivatives were mentioned previously as categorized based on other chemical classes. With this in mind, several specific examples of scented compounds of furanone derivatives with a non-limiting approximate description of their respective scents include: 4-hydroxy-2,5-dimethylfuran-3-one (strawberry), 2-ethyl-4-hydroxy-5-methyl-3 (2H)-furanone (shoyu, soy), 5-ethyl-3-hydroxy-4-methyl-2 (5H)-furanone (maple), 4-acetoxy-2,5-dimethyl-3 (2H)-furanone (strawberry), 4-hydroxy-5-methyl-3 (2H)-furanone (toffee), 2,5-dimethyl-3 (2H)-furanone (mango), 2,5-dimethyl-4-methoxy-3 (2H)-furanone (strawberry), 2-ethyl-4-hydroxy-5-methylfuran-3-one (stawberry), 4,5-dimethyl-3-hydroxy-2,5-dihydrofuran-2-one (caramel), or a combination thereof.

In another specific example, the scented compound can be included from those previously tested for safety in consumer products. For example, the scented compound can include a compound from a list of substances generally recognized as safe by the United States Food and Drug Administration (21CFR182.6, as revised Apr. 1, 2019). In accordance with this, the scented compound can include acetaldehyde, acetoin, anethole, benzaldehyde, N-butyric acid, carvol, cinnemaldehyde, citral, decanal, ethyl acetate, ethyl butyrate, 3-methyl-3-phenyl glycidic acid ethyl ester, ethyl vanillin, geraniol, geranyl acetate, limonene, linalool, linalyl acetate, methyl anthranilate, piperonal, vanillin, or a combination thereof.

The concentration of the scented compound in the scent agent can be sufficient that a noticeable scent is imparted to the finished three-dimensional printed article when the scent agent is applied to the powder build material during three-dimensional printing. Some scented compounds can have a more powerful scent than others. Therefore, some scented compounds can be used at smaller concentrations while others can be used at greater concentrations. In various examples, the sent additive can be present in the scent agent in an amount from about 0.05 wt % to about 20 wt % based on the total weight of the scent agent. In other examples, the concentration of the scented compound can be from about 0.1 wt % to about 8 wt % or from about 0.5 wt % to about 5 wt %. In some examples, the scent agent can include multiple different scented compounds. In such examples, individual scented compounds can be included at the concentrations described above or the total amount of scented compound can be at the concentrations described above.

### Detailing Agents

In further examples, multi-fluid kits or three-dimensional printing kits can include a detailing agent. The detailing agent can include a detailing compound. The detailing compound can be capable of reducing the temperature of the powder bed material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. In some cases the powder bed can be preheated to a preheat temperature within about 10° C. to about 70° C. of the fusing temperature of the polymer powder. Depending on the type of polymer powder used, the preheat temperature can be in the range of about 90° C. to about 200° C. or more. The detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not cause the powder printed with the detailing agent to fuse when exposed to the radiation energy.

The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

In certain examples, the detailing agent can include from about 1 wt % to about 10 wt % organic co-solvent, from about 1 wt % to about 20 wt % high boiling point solvent, from about 0.1 wt % to about 2 wt % surfactant, from about 0.1 wt % to about 5 wt % anti-kogation agent, from about 0.01 wt % to about 5 wt % chelating agent, from about 0.01 wt % to about 4 wt % biocide, and the balance can be deionized water.

### Methods of Making Three-Dimensional Printed Articles

The present disclosure also describes methods of making three-dimensional printed articles. FIG. 4 shows a flowchart illustrating one example method 400 of making a three-dimensional printed article. The method can include iteratively applying 410 individual layers of a powder bed material to a powder bed, and based on a three-dimensional object model, selectively applying 420 a fusing agent onto the individual layers of powder bed material. The fusing agent can include water and a radiation absorber to absorb radiation energy and convert the radiation energy to heat, and the powder bed material can include polymer particles. In further detail, the method can further include, based on the three-dimensional object model, selectively applying 430 a scented compound dissolved in an aqueous liquid vehicle including water and an organic co-solvent to the powder bed material, and exposing 440 the powder bed to radiation energy to selectively fuse the polymer particles in contact with the radiation absorber at individual layers and thereby forming the three-dimensional printed article. In this example, the organic co-solvent can include an aliphatic polyol, an esterified aliphatic polyol, or a combination thereof.

In one example, the scented compound can be present in a scent agent that is a separate fluid relative to the fusing agent. In another example, the scented compound can be present in the fusing agent, which includes the aqueous liquid. In another example, applying the fusing agent and scented compound can include ejecting the fusing agent from a fluidjet printhead with the scented compound included in the fusing agent, or ejecting the fusing agent and a separate scent agent from the fluidjet printhead, wherein the scented compound is included in the separate scent agent. In other examples, the scent agent can be selectively applied on certain areas of the powder bed where the particular scent imparted by the scent agent is desired. The scent agent can be applied in the same areas where the fusing agent is applied so that the entire three-dimensional printed article has a uniform scent, e.g., applied within (carried by) the fusing agent or applied from a separate scent agent at locations coinciding with application of the fusing agent. In other examples, the scent agent can be applied in some portions of the three-dimensional printed article but not in other portions, which can remain unscented, e.g., using a separate scent agent. In still further examples, multiple scent agents can be selectively applied to impart multiple scents to different portions of the three-dimensional printed article.

The fusing agent, scent agent, and/or detailing agent as may be applicable for a given application can be ejected or digitally jetted onto the powder bed using fluidjet printheads. The amount of the fusing agent used can be calibrated based on the concentration of radiation absorber in the fusing agent, the level of fusing desired for the polymer particles, and other factors. In some examples, the amount of fusing agent printed can be sufficient to contact the radiation absorber with the full layer of polymer powder. For example, if individual layers of polymer powder is 100 microns thick, then the fusing agent can penetrate 100 microns into the polymer powder. Thus the fusing agent can heat the polymer powder throughout the entire layer so that the layer can coalesce and bond to the layer below. After forming a solid layer, a new layer of loose powder can be formed, either by lowering the powder bed or by raising the height of a powder roller and rolling a new layer of powder.

In some examples, the entire powder bed can be preheated to a temperature below the melting or softening point of the polymer powder. In one example, the preheat temperature can be from about 10° C. to about 30° C. below the melting or softening point. In another example, the preheat temperature can be within 50° C. of the melting of softening point. In a particular example, the preheat temperature can be from about 160° C. to about 170° C. and the polymer powder can be polyamide 12 powder. In another example, the preheat temperature can be about 90° C. to about 100° C. and the polymer powder can be thermoplastic polyamide or thermoplastic polyurethane. Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polymer powder below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polymer particles with the fusing agent printed thereon, while the unprinted polymer particles do not absorb as much light and remain at a lower temperature.

Depending on the amount of radiation absorber present in the polymer powder, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass

The three-dimensional printed article can be formed by jetting a fusing agent onto layers of powder bed build material according to a three-dimensional object model. Three-dimensional object models can in some examples be created using computer aided design (CAD) software. Three-dimensional object models can be stored in any suitable file format. In some examples, a three-dimensional printed article as described herein can be based on a single three-dimensional object model. The three-dimensional object model can define the three-dimensional shape of the article. In some examples, the three-dimensional object model can also include a particular three-dimensional portion of the object that is to include a scented compound. Thus, this particular portion can define areas where the scent agent will be jetted. Other information may also be included, such as structures to be formed of additional different materials or color data for printing the article with various colors at different locations on the article. The three-dimensional object model may also include features or materials specifically related to jetting fluids on layers of powder bed material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, concentration of the scented compound, and so on. All this information can be contained in a single three-dimensional object file or a combination of multiple files. The three-dimensional printed article can be made based on the three-dimensional object model. As used herein, “based on the three-dimensional object model” can refer to printing using a single three-dimensional object model file or a combination of multiple three-dimensional object models that together define the article. In certain examples, software can be used to convert a three-dimensional object model to instructions for a three-dimensional printer to form the article by building up individual layers of build material.

In an example of the three-dimensional printing process, a thin layer of polymer powder can be spread on a bed to form a powder bed. At the beginning of the process, the powder bed can be empty because no polymer particles have been spread at that point. For the first layer, the polymer particles can be spread onto an empty build platform. The build platform can be a flat surface made of a material sufficient to withstand the heating conditions of the three-dimensional printing process, such as a metal. Thus, “applying individual build material layers of polymer particles to a powder bed” includes spreading polymer particles onto the empty build platform for the first layer. In other examples, a number of initial layers of polymer powder can be spread before the printing begins. These “blank” layers of powder bed material can in some examples number from about 10 to about 500, from about 10 to about 200, or from about 10 to about 100. In some cases, spreading multiple layers of powder before beginning the print can increase temperature uniformity of the three-dimensional printed article. A fluid jet printing head, such as an inkjet print head, can then be used to print a fusing agent including a radiation absorber over portions of the powder bed corresponding to a thin layer of the three-dimensional article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polymer powder can be spread over the powder bed and the process can be repeated to form additional layers until a complete three-dimensional article is printed. Thus, “applying individual build material layers of polymer particles to a powder bed” also includes spreading layers of polymer particles over the loose particles and fused layers beneath the new layer of polymer particles.

### Definitions

It is noted that, as used in this specification and the appended claims, the singular forms “a,” “an,” and “the” include plural referents unless the context clearly dictates otherwise.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum. Some dyes, however, are used as an electromagnetic radiation absorber and may or may not impart a visible color where applied.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe pigment colorants, and also other pigments such as organometallics, ferrites, ceramics, etc. In one specific aspect, however, the pigment is a pigment colorant.

As used herein, “applying” when referring to fusing agent and/or detailing agent, for example, refers to any technology that can be used to put or place the respective fluid agent on or into a layer of powder bed material for forming three-dimensional articles. For example, “applying” may refer to “jetting,” “ejecting,” “dropping,” “spraying,” or the like.

As used herein, “jetting” or “ejecting” refers to applying fluid agents or other compositions by expelling from ejection or jetting architecture, such as ink-jet architecture. Ink-jet architecture can include thermal or piezo architecture. Additionally, such architecture can be configured to print varying drop sizes such as from about 3 picoliters to less than about 10 picoliters, or to less than about 20 picoliters, or to less than about 30 picoliters, or to less than about 50 picoliters, etc.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the Mastersizer™ 3000 available from Malvern Panalytical. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context. When using the term “substantial” or “substantially” in the negative, e.g., substantially devoid of a material, what is meant is that none of that material is present, or at most, trace amounts could be present at a concentration that would not impact the function or properties of the composition as a whole.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though an individual member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

### EXAMPLES

The following illustrates examples of the present disclosure. However, it is to be understood that the following are merely illustrative of the application of the principles of the present disclosure. Numerous modifications and alternative devices, methods, and systems may be devised without departing from the spirit and scope of the present disclosure. The appended claims are intended to cover such modifications and arrangements.

### Example 1—Preparation of Scent Agent

A scent agent was prepared from the off-the-shelf scented fluid formulation, which is a flavoring known as “Super Strength Bubble Gum Flavor” from LorAnn Oils (USA), hereinafter “Bubble Gum Flavor.” The product label indicates that it includes propylene glycol, ethyl alcohol, natural and artificial flavors, water, and FD&C red 40. To prepare the scent agent in a manner suitable for fluid ejection from a thermal inkjet printhead, the following formulation was prepared in accordance with Table 1.

TABLE 1
Bubble Gum Scent Agent

| Ingredient | Wt % |
|---|---|
| Surfactant 1 | 0.5 |
| Surfactant 2 | 1.5 |
| Chelator | 0.05 |
| Bubble Gum Flavor | 15 |
| (Full Formulation) | |
| Water | Balance |

Notably, the Bubble Gum scent agent is formulated to include the scent compound (which comes pre-dissolved in an organic co-solvent including propylene glycol) and then is further formulated for thermal inkjet printing. In this example, no additional organic co-solvents beyond what is already included in the Bubble Gum Flavor was added. However, the bubble gum scent agent of the present example was formulated to include added ingredients to provide acceptable thermal jettability properties, such as printhead reliability, decap performance, kogation performance, etc. The added ingredients in this example include added surfactant and a small amount of chelator, but in other examples, the added ingredients could alternatively or additionally include added water, added organic co-solvent, added anti-kogation additives, e.g., surfactant(s), humectant, etc., and/or other added components.

By way of example, the scent agent prepared in accordance with Table 1 was printed from an HP desktop inkjet printer with good jettability and greater than about a 16 second decap performance time. The printability of the scent compound was confirmed by including a very small amount of magenta dye in the formulation to provide visible markings of an otherwise clear liquid formulation. Furthermore, the scent agent had a distinct smell of bubble gum similar to that of the Bubble Gum Flavor used to prepare the scent agent.

### Example 2—Preparation of Scented Fusing Agent

A fusing agent is prepared by adding a carbon black pigment or a tungsten bronze compound, for example, as a radiation absorber to the scent agent of Table 1. This formulation can provide the dual function of assisting with the fusing of polymer particles of a powder bed material (when exposed to an appropriate frequency and intensity of electromagnetic radiation), as well as provide a bubble gum scent similar to that of the scent agent of Example 1.

### Example 3—Three-Dimensional Printing

Following the preparation of the scent agent of Example 1 (Table 1), several three-dimensional print tests were carried out using a multi-jet fusion process, e.g., iteratively applying fusing agent and scent agent onto a powder bed material of polymer particles. The fusing agent and the scent agent were loaded in an HP Multi Jet Fusion™ three-dimensional test printer. The powder bed material was polyamide-12 powder. The shapes printed were small three-dimensional cubes. As a control, some cubes were printed without the scent agent.

There was no obvious difference in the shape of the cubes prepared with and without scent agent; however, there was a strong difference in odor, e.g., the cubes with the scent agent had a strong scent of “bubble gum.” To further corroborate that the parts could be distinguished by scent, a number of subjects were asked to analyze the parts for noticeable possible fragrance. From this survey, 9 out of 10 subjects were able to correctly identify the scent as a bubble gum fragrance, and 10 out of 10 subjects identified the control cubes as having no fragrance.

What is claimed is:

1. A multi-fluid kit for three-dimensional printing comprising:
a fusing agent comprising water and a radiation absorber, wherein the radiation absorber absorbs radiation energy and converts the radiation energy to heat; and
a scent agent comprising a scented compound dissolved in an aqueous liquid vehicle that includes water and organic co-solvent, wherein the organic co-solvent includes an aliphatic polyol, an esterified aliphatic polyol, or a combination thereof.

2. The multi-fluid kit of claim 1, wherein the organic co-solvent includes the aliphatic polyol, wherein the aliphatic polyol includes 1,3-butylene glycol, 1,2-propylene glycol, glycerol, a monoglyceride, or a combination thereof.

3. The multi-fluid kit of claim 1, wherein the organic co-solvent includes the esterified aliphatic polyol, wherein the esterified aliphatic polyol includes triethylene citrate, ethyl acetate, a monoglyceride, a diglyceride, a propylene glycol ester, a butylene glycol ester, or a combination thereof.

4. The multi-fluid kit of claim 1, wherein the scented compound is present in the scent agent in an amount from about 0.05 wt % to about 20 wt % based on the total weight of the scent agent.

5. The multi-fluid kit of claim 1, wherein the scented compound comprises a scented ester compound, a scented linear terpene compound, a scented cyclic terpene compound, a scented aromatic compound, a scented alcohol compound, a scented aldehyde compound, a scented ketone compound, a scented lactone compound, a scented thiol compound, or a combination thereof.

6. The multi-fluid kit of claim 1, further comprising a detailing agent, wherein the detailing agent comprises a detailing compound, and wherein the detailing compound reduces the temperature of powder bed material onto which the detailing agent is applied.

7. A three-dimensional printing kit comprising:
a powder bed material comprising polymer particles; and
a fusing agent to selectively apply to the powder bed material, wherein the fusing agent comprises an aqueous liquid vehicle including water and an organic co-solvent, a radiation absorber to absorb radiation energy and convert the radiation energy to heat, and a scented compound dissolved in the aqueous liquid vehicle, wherein the organic co-solvent includes an aliphatic polyol, an esterified aliphatic polyol, or a combination thereof.

8. The three-dimensional printing kit of claim 7, wherein the polymer particles comprise polyamide 6, polyamide 9, polyamide 11, polyamide 12, polyamide 66, polyamide 612, thermoplastic polyamide, polyamide copolymer, polyethylene, thermoplastic polyurethane, polypropylene, polyester, polycarbonate, polyether ketone, polyacrylate, polystyrene, polyvinylidene fluoride, polyvinylidene fluoride copolymer, poly (vinylidene fluoride-trifluoroethylene), poly (vinylidene fluoride-trifluoroethylene-chlorotrifluoroethylene), wax, or a combination thereof.

9. The three-dimensional printing kit of claim 7, wherein the scented compound is present in the fusing agent in an amount from about 0.05 wt % to about 20 wt % based on the total weight of the fusing agent.

10. The three-dimensional printing kit of claim 7, wherein the scented compound comprises a scented ester compound, a scented linear terpene compound, a scented cyclic terpene compound, a scented aromatic compound, a scented alcohol compound, a scented aldehyde compound, a scented ketone compound, a scented lactone compound, a scented thiol compound, or a combination thereof.

11. The three-dimensional printing kit of claim 7, further comprising a detailing agent, wherein the detailing agent comprises a detailing compound, and wherein the detailing compound reduces the temperature of powder bed material onto which the detailing agent is applied.

12. A method of making a three-dimensional printed article comprising:
iteratively applying individual layers of a powder bed material to a powder bed, wherein the powder bed material comprises polymer particles;
based on a three-dimensional object model, selectively applying a fusing agent onto the individual layers of powder bed material, wherein the fusing agent comprises water and a radiation absorber, wherein the radiation absorber absorbs radiation energy and converts the radiation energy to heat;
based on the three-dimensional object model, selectively applying a scented compound dissolved in an aqueous liquid vehicle including water and an organic co-solvent to the powder bed material, wherein the organic co-solvent includes an aliphatic polyol, an esterified aliphatic polyol, or a combination thereof; and
exposing the powder bed to radiation energy to selectively fuse the polymer particles in contact with the radiation absorber at individual layers and thereby form the three-dimensional printed article.

13. The method of claim 12, wherein the scented compound is present in a scent agent that is separate fluid relative to the fusing agent.

14. The method of claim 12, wherein the scented compound is present in the fusing agent, and wherein the fusing agent includes the aqueous liquid vehicle including water and the organic co-solvent.

15. The method of claim 12, wherein applying the fusing agent and scented compound comprises:
ejecting the fusing agent from a fluidjet printhead, wherein the scented compound is included in the fusing agent, or
ejecting the fusing agent and a separate scent agent from the fluidjet printhead, wherein the scented compound is included in the separate scent agent.
